(19) United States
(12) Patent Application Publication
(10) Pub. No.: US 2023/0386056 A1
(43) Pub. Date: Nov. 30, 2023

(54) SYSTEMS AND TECHNIQUES FOR DEPTH ESTIMATION

(71) Applicant: QUALCOMM Incorporated, San Diego, CA (US)

(72) Inventors: Mehak MANIKTALA, San Diego, CA (US); Anirudh RADHAKRISHNAN, San Diego, CA (US)

(21) Appl. No.: 18/046,060

(22) Filed: Oct. 12, 2022

Related U.S. Application Data
(60) Provisional application No. 63/347,425, filed on May 31, 2022.

(51) Int. Cl. G06T 7/55

(52) U.S. Cl. CPC G06T 7/55; G06T 2207/20081; G06T 2207/20084

(57) ABSTRACT

The present disclosure generally relates to depth estimation. For example, aspects of the present disclosure include systems and techniques for performing depth estimation using filtered image data. Certain aspects provide an apparatus for processing frame data. The apparatus generally includes at least one memory; and at least one processor coupled to the at least one memory. The at least one processor may obtain a plurality of images for image processing, extract one or more features associated with each of the plurality of images, and analyze whether each of the plurality of images is a candidate for the image processing based on the one or more features. The at least one processor may also select a subset of the plurality of images based on analyzing the plurality of images and perform the image processing based on the selected subset of the plurality of images.

### CROSS-REFERENCE TO RELATED APPLICATION

This application claims priority to provisional patent application U.S. Provisional Application No. 63/347,425, filed on May 31, 2022, the content of which is incorporated by reference herein in its entirety.

### FIELD

The present disclosure generally relates to depth estimation. For example, aspects of the present disclosure include systems and techniques for performing depth estimation using filtered image data.

### BACKGROUND

A camera is a device that receives light and captures image frames, such as still images or video frames, using an image sensor. Cameras may include processors, such as image signal processors (ISPs), that can receive one or more image frames and process the one or more image frames. For example, a raw image frame captured by a camera sensor can be processed by an ISP to generate a final image. Cameras can be configured with a variety of image capture and image processing settings to alter the appearance of an image. Some camera settings are determined and applied before or during capture of the photograph, such as ISO, exposure time, aperture size, f/stop, shutter speed, focus, and gain. Other camera settings can configure post-processing of a photograph, such as alterations to contrast, brightness, saturation, sharpness, levels, curves, or colors.

Traditional image signal processors (ISPs) have separate discrete blocks that address the various partitions of the image-based problem space. For example, a typical ISP has discrete functional blocks that each apply a specific operation to raw camera sensor data to create a final output image. Such functional blocks can include blocks for demosaicing, noise reduction (denoising), color processing, tone mapping, among many other image processing functions. Each of these functional blocks contains many pre-tuned parameters, resulting in an ISP with a large number of pre-tuned parameters (e.g., over 10,000) that must be re-tuned according to the tuning preference of each customer. Such hand-tuning of parameters is very time-consuming and expensive, and thus is generally performed once. Once tuned, a traditional ISP generally uses a limited set of tuning settings for processing images. For example, there may be one set of tuning settings for processing low light images, and a second set of tuning settings for processing bright light images. For any individual image, a static tuning setting is used for processing the full image.

### SUMMARY

Certain aspects provide an apparatus for processing frame data. The apparatus generally includes at least one memory and at least one processor coupled to the at least one memory. The at least one processor is configured to: obtain a plurality of images for image processing; extract one or more features associated with each of the plurality of images; analyze, via a first machine learning model, whether each of the plurality of images is a candidate for the image processing based on the one or more features; select, via the first machine learning model, a subset of the plurality of images based on analyzing the plurality of images; and perform the image processing based on the selected subset of the plurality of images.

Certain aspects provide a method for processing frame data. The method generally includes: obtaining a plurality of images for image processing; extracting one or more features associated with each of the plurality of images; analyzing, via a first machine learning model, whether each of the plurality of images is a candidate for the image processing based on the one or more features; selecting, via the first machine learning model, a subset of the plurality of images based on analyzing the plurality of images; and performing the image processing based on the selected subset of the plurality of images.

A non-transitory computer-readable medium is provided having stored thereon instructions that, when executed by one or more processors, cause the one or more processors to: obtain a plurality of images for image processing; extract one or more features associated with each of the plurality of images; analyze, via a first machine learning model, whether each of the plurality of images is a candidate for the image processing based on the one or more features; select, via the first machine learning model, a subset of the plurality of images based on analyzing the plurality of images; and perform the image processing based on the selected subset of the plurality of images.

An apparatus for processing frame data is provided. The apparatus generally includes: means for obtaining a plurality of images for image processing; means for extracting one or more features associated with each of the plurality of images; means for analyzing, via a first machine learning model, whether each of the plurality of images is a candidate for the image processing based on the one or more features; means for selecting, via the first machine learning model, a subset of the plurality of images based on analyzing the plurality of images; and means for performing the image processing based on the selected subset of the plurality of images.

In some aspects, each of the apparatuses described above is, can be part of, or can include a mobile device (e.g., a mobile telephone or so-called “smart phone” or other mobile device), an extended reality (XR) device (e.g., a virtual reality (VR) device, an augmented reality (AR) device, or a mixed reality (MR) device), a wearable device, a camera system, a personal computer, a laptop computer, a tablet computer, a server computer, a vehicle or computing device or component of a vehicle, a robotics device or system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a block diagram illustrating an example architecture of an image capture and processing system, in accordance with certain aspects of the present disclosure.

FIG. 2 illustrates a frame from a scene to be used for depth estimation, in accordance with certain aspects of the present disclosure.

FIGS. 3A and 3B illustrate a three-dimensional (3D) reconstruction of a scene using estimated depth without and with image filtering, respectively, in accordance with certain aspects of the present disclosure.

FIG. 4 illustrates example techniques for supervised learning of an image filtering model, in accordance with certain aspects of the present disclosure.

FIG. 5 illustrates techniques for generating image labels, in accordance with certain aspects of the present disclosure.

FIGS. 6A and 6B illustrate example techniques for depth estimation using an image filtering system, in accordance with certain aspects of the present disclosure.

FIG. 7 is a flow diagram illustrating operations for processing image data, in accordance with certain aspects of the present disclosure.

FIG. 8 is a block diagram illustrating an example of a neural network, in accordance with certain aspects of the present disclosure.

FIG. 9 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Image capture devices capture images by receiving light from a scene using an image sensor with an array of photodiodes. An image signal processor (ISP) then processes the image data captured by the photodiodes of the image sensor into an image that can be stored and viewed by a user. How the scene is depicted in the image depends in part on capture settings that control how much light is received by the image sensor, such as exposure time settings and aperture size settings. How the scene is depicted in the image also depends on how the ISP is tuned to process the photodiode data captured by the image sensor into an image.

An ISP can be designed to use one or more trained machine learning (ML) models (e.g., trained neural networks (NNs) and/or other trained ML models). For example, a fully ML-based ISP can pass image data into one or more neural networks (or other trained ML models), which can output an image that can be stored and viewed by a user. An ML-based ISP can be more customizable than a pre-tuned ISP. For example, an ML-based ISP can process different images in different ways, for instance, based on the different scenes depicted in the different images. In some cases, trained ML models may be used to estimate depth of frames using deep learning (DL).

DL is being increasingly used to estimate depth in several fields such as extended reality (XR), autonomous driving, and object tracking. Within XR, depth estimation is used for three-dimensional (3D) reconstruction of features in captured images among other applications. For the purpose of 3D reconstruction, the DL technique provides power-efficient and cost-effective alternatives to depth sensors. Depth sensors are a form of three-dimensional (3D) range finder that acquire multi-point distance information of a scene or environment. A drawback of estimation errors can sometimes outweigh the advantages of using DL depth estimation. The estimation errors may arise because of domain gaps (e.g., changes in input distribution between training and real-world use-cases). Different camera/recording equipment may have different image quality, exposure time, camera gains, histogram spread, sensitivity to light, etc., altering the input distribution. Some solutions to reduce estimation errors involve retraining the DL models (e.g., with new datasets, new neural architecture, or both). However, continuously retraining depth estimating networks for each new camera may be infeasible (time, resources, and monetarily). Therefore, techniques are needed to address the drawback of estimation errors, particularly for domain gaps, without needing to retrain the DL models for depth estimation.

Depth estimation may be performed based on single or monocular frames/images. Depth estimating neural networks (also referred to as depth networks) are trained to estimate the depth of each pixel in an image. There may be two categories of depth networks: non-sparse networks which use grayscale images (or color images such as red-green-blue (RGB) images) as input or sparse networks that use two inputs, grayscale (or RGB) images and sparse points depth (e.g., corner points detected in grayscale images using, e.g., Harris Corner detection algorithm). Both categories of networks may use an encoder-decoder architecture, in some implementations. The dataset used for these networks may include a ScanNet database including millions of samples for training and many samples for testing. Many monocular-depth-estimation-based 3D reconstruction pipelines use depth map fusion methods. These fusion methods may fuse the frames (e.g., and in some cases, filter the frames) into a Truncated Signed Distance Function (TSDF) volume. The reconstruction may be extracted using a Marching Cubes algorithm from the fused TSDF volume.

The domain gap noted above may occur when an algorithm encounters an input distribution during deployment that is different from the dataset used to train it. For instance, a domain gap can arise for depth estimation because of differences in the camera/recording equipment.

Systems, apparatuses, processes (also referred to as methods), and computer-readable media (collectively referred to as “systems and techniques”) are described herein for providing an image filtering system that improves 3D reconstruction from estimated depth. The image filtering system implements a filtering technique, which may also be referred to as a suboptimal-image filtering technique (SIFT). As used herein, image filtering generally refers to a technique that selects a subset of images to be used for a particular purpose, such as depth estimation. For example, given a real-world scene (including frames or images) and a depth network (e.g., a monocular depth network) that may or may not be trained on a particular recording for depth estimation, the image filtering system may be used at inference time (after the system has been trained) to identify and filter out (e.g., deselect) images that are likely to have high errors in depth estimation. The image filtering system may thus help improve 3D reconstruction of a scene generated using the depth network.

In some aspects, the image filtering system may be implemented as a supervised machine learning approach that can train sifters (e.g., binary classifiers which is a ML model with two classes, filter or retain) for any depth network using any dataset. As used herein, a sifter generally refers to any component that selects a subset of images to be used for depth estimation. The image filtering system improves 3D reconstruction irrespective of domain gaps. The operation of the image filtering system in improving depth estimation has been verified for different depth networks and scene recordings (e.g., some with and some without domain gaps from the depth networks' training dataset). The machine learning (ML) model for implementing the image filtering system described herein takes less time and resources to train than existing depth networks. The image filter system allows for sifting of images before estimating depth, possibly reducing the inference overhead and, hence, the inference time. The image filtering system acts as more of a white box than DL to enhance the 3D reconstruction from DL solutions because sifters are easier to model and interpret. The image filter system may be generalized to use cases beyond depth estimation. For example, any neural network that takes in images as input may use the image filtering system to improve image processing.

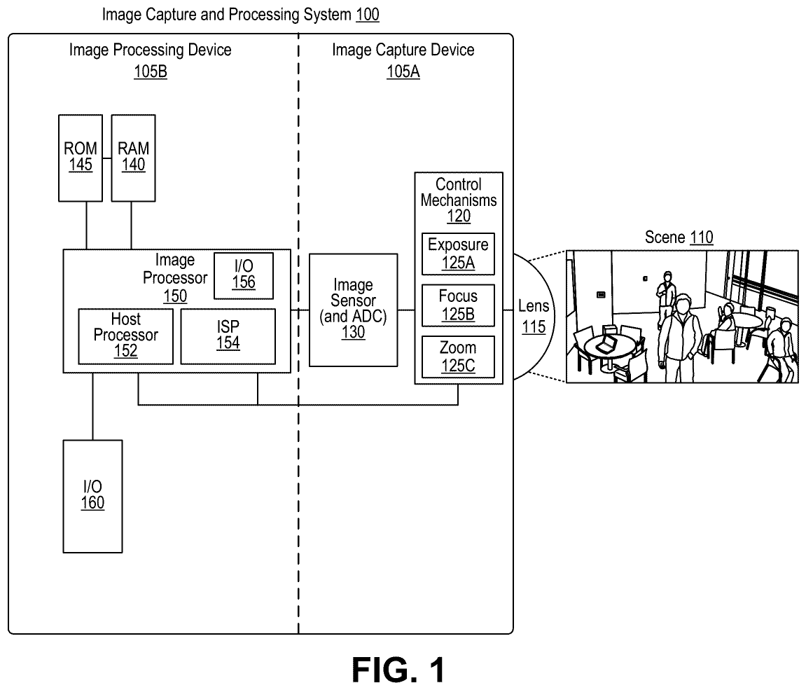

Various aspects of the application will be described with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 910 discussed with respect to the computing system 900. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth m, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/5020, read-only memory (ROM) 145/5025, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 935, any other input devices 945, or some combination thereof. In some cases, a caption may be input into the image processing device 105B through a physical keyboard or keypad of the I/O devices 160, or through a virtual keyboard or keypad of a touchscreen of the I/O devices 160. The I/O device 160 may include one or more ports, jacks, or other connectors that enable a wired connection between the system 100 and one or more peripheral devices, over which the system 100 may receive data from the one or more peripheral device and/or transmit data to the one or more peripheral devices. The I/O device 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O device 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

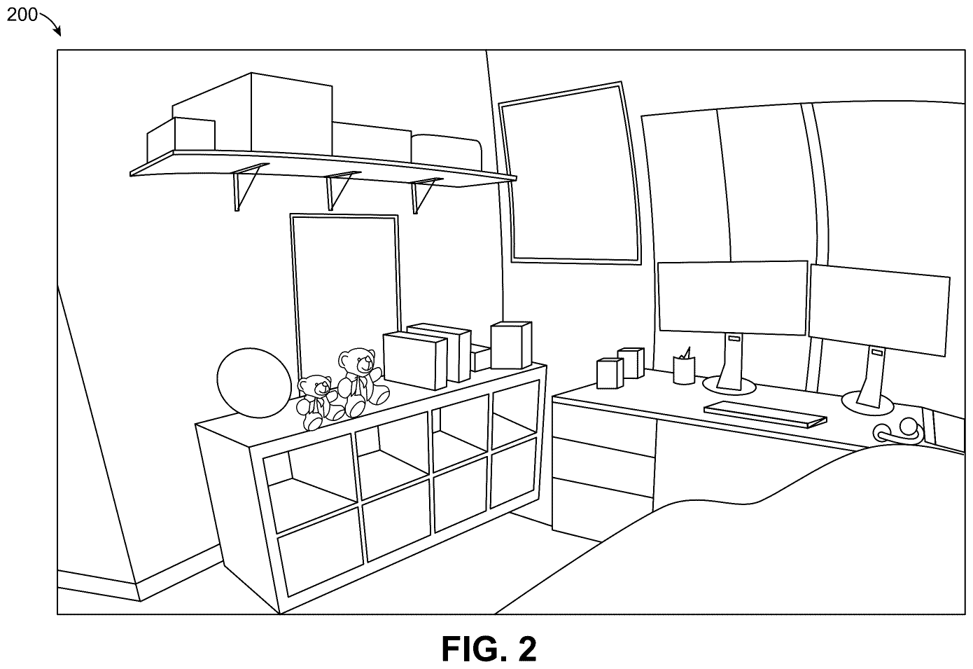

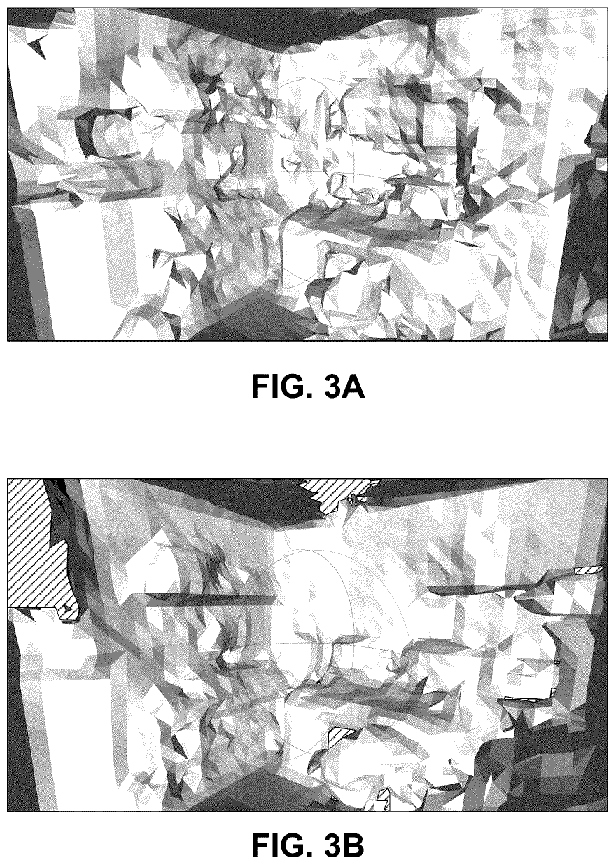

FIG. 2 illustrates a scene 200 to be used for depth estimation, in accordance with certain aspects of the present disclosure. The image shows a scene recording for a home office. In some cases, there may be a domain gap between the recording and a dataset (e.g., ScanNet dataset) used to train a depth network for depth estimation. A depth network may be used to generate a 3D reconstruction from depth estimation per frame of the recording of the scene 200 with or without image filtering, as shown in FIGS. 3A and 3B, respectively.

FIGS. 3A and 3B illustrate 3D reconstructions generated from depth estimation per frame of the scene 200 without and with image filtering, respectively, in accordance with certain aspects of the present disclosure. As shown in FIG. 3B, using image filtering leads to a cleaner 3D reconstruction with smoother walls, better definition of objects, and smoother reconstruction of windows (e.g., a generally difficult problem to solve for depth estimation). In some cases, using image filtering may lead to patches of missing 3D reconstruction (e.g., top-left region in FIG. 3B) because the sifter may remove more frames than needed. The patches of missing 3D construction are shown in FIG. 3B with slanted lines. This may be addressed by tuning sifters' training process (e.g., adjusting hyperparameters that can lead to a better trade off between recall and area under receiver operating characteristics curve (AUC)).

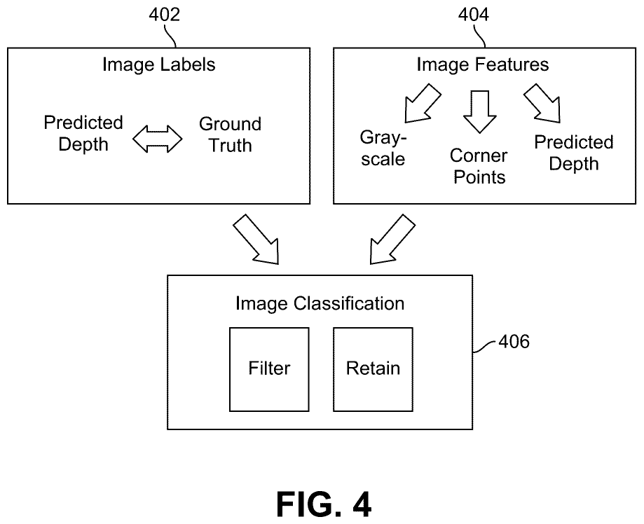

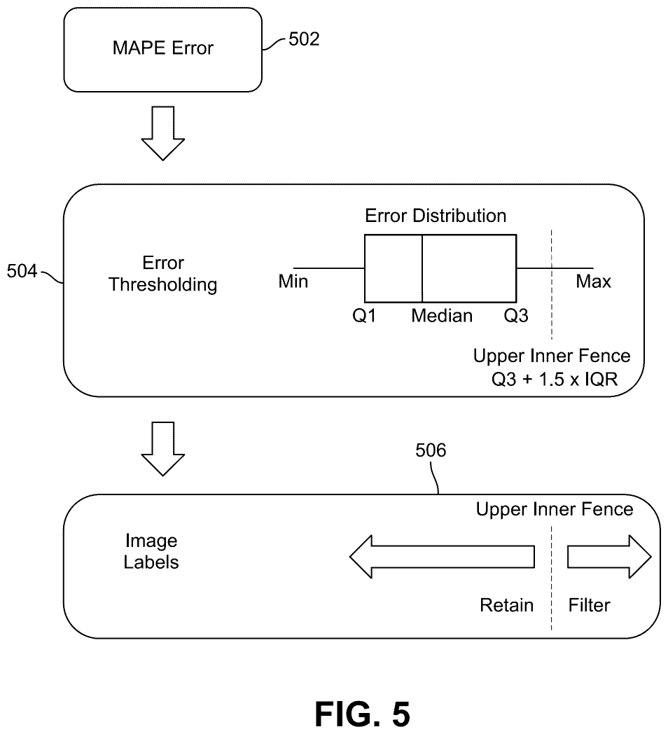

FIG. 4 illustrates example techniques for supervised learning of a sifter for the image filter system (e.g., image classification model), in accordance with certain aspects of the present disclosure. At block 402, image labels may be added to image datasets. The image labels may be generated by comparing a predicted depth (e.g., predicted depth associated with each pixel) with ground truth (e.g., actual depth associated with each pixel), as described in more detail with respect to FIG. 5. At block 404, image features (e.g., grayscale parameters, corner points, predicted depth) may be added for each image. Image features may be added using the depth network's input and/or output, referred to herein as input and output features. At block 406, the sifter (e.g., a binary classifier) may be trained using the image features and labels.

In some aspects, image features may be extracted from one or more sources. For example, a first source may be the grayscale image. Per grayscale image, average value, the standard deviation in grayscale values, grayscale contrast, Shannon entropy, edge-based features (e.g., detected using Canny's algorithm), percentage of edge pixels in the image, Shannon entropy, or any combination thereof, may be used as features. A second source used for extraction of features may be corner points, including corner points of features in grayscale images (e.g., detected using Harris Corner detection algorithm). Depth of corner points may be used such as the average depth, standard deviation of depths, range (max-min) of depths, Shannon entropy, or any combination thereof. Spatial spread may also be used for features extraction, including covariance matrix's trace, covariance matrix's largest eigenvalue, maximum of all pair distance using Manhattan distance, maximum of all pair distance using Euclidean distance, mean of all pair distance using Manhattan distance, mean of all pair distance using Euclidean distance, proportion of corner points in the image, number of clusters using the density-based spatial clustering of applications with noise (DBSCAN) algorithm, number of outliers using the DBSCAN clustering algorithm, or any combination thereof. In some cases, predicted depth per image may be used as a feature, including the range (max-min) of depth, average value, standard deviation, third quartile (e.g., of MAPE), and Shannon entropy. While using grayscale images is provided as an example to facilitate understanding, features may be extracted for training from any suitable images (e.g., red-green-blue (RGB) images). Both the input features (e.g., features extracted using grayscale (and/or RGB) images and/or corner points) and the depth network output features (e.g., predicted depth as output by a depth network) can provide useful information about the instances where the particular frame is likely to perform poorly for depth estimation. In some cases, only the input features may be used for filtering of images/frames before estimating depth, possibly reducing inference time as described herein.

FIG. 5 illustrates example techniques for generating image labels, in accordance with certain aspects of the present disclosure. At block 502, a mean absolute percentage error (MAPE) may be calculated for each frame. While MAPE is provided as an example error metric that may be used to facilitate understanding of aspects described herein, other suitable error metrics (e.g., mean absolute error, or root measure square error) may be used. The MAPE error may be calculated using the equation:

$$Image M A P E = \frac{1}{R \times C} {\sum }_{p = 1}^{R \times C} \vert \frac{y - \hat{y}}{y} \vert$$

where R is the number of rows in the frame, C is the number of columns in the frame, p is an identifier of each pixel, y is the depth ground truth for the pixel, and ŷ is the predicted depth for the pixel. At block 504, error thresholding may be performed. For example, it may be determined whether the calculated image MAPE is greater than a threshold. The threshold may be calculated as:

Q3+1.5×IQR

where Q3 is the third quartile of the error distribution of the image dataset, IQR is the interquartile range (e.g., Q3-Q1), and Q1 is the first quartile of the error distribution of the image dataset. In some cases, Q3 may be used as the threshold for image filtering. While example error thresholds are provided, any suitable error threshold may be used. At block 506, any frame with a MAPE that is greater than or equal to the threshold may be labeled as filter (e.g., filtered out from 3D reconstruction) and any frame with an MAPE that is less than the threshold may be labeled as retain (e.g., retained for depth estimation).

Once the image features are generated, the sifter may be trained using the image features and labels. As described, sifters may be binary classifiers with classes (e.g., filter or retain). In some aspects, the binary classifier may be implemented as Sklearn Python Package (e.g., random forest and XG Boost, which are ensemble models) or AutoML (Automated Machine Learning) python package tree-based pipeline optimization tool (TPOT) that uses genetic programming to find a classification pipeline.

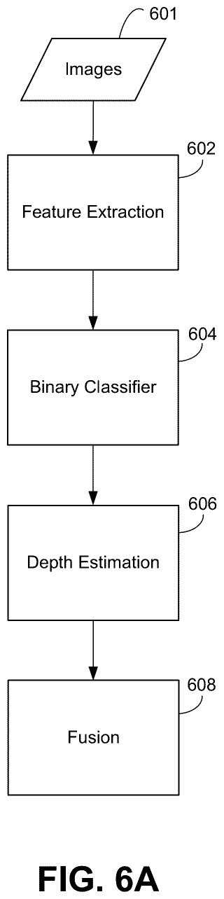

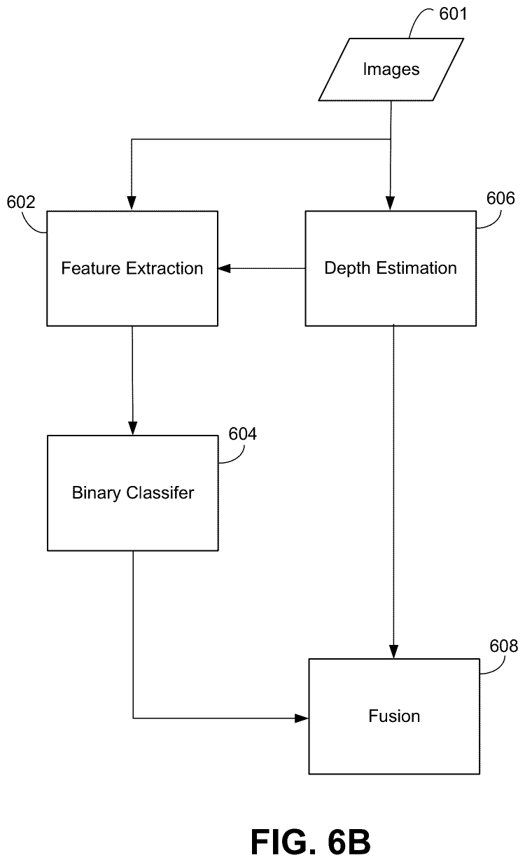

FIGS. 6A and 6B illustrate example techniques for depth estimation using an image

filtering system, in accordance with certain aspects of the present disclosure. As shown in FIG. 6A, a feature extraction component 602 may extract one or more features from images 601 for depth estimation. The one or more features may include the input features described herein (e.g., features extracted using grayscale (and/or RGB) images and/or corner points). The extracted features may be provided to the binary classifier 604, including a trained machine learning model (e.g., as described with respect to FIG. 4). The binary classifier 604 may select a subset of images (from the one or more images 601) that are candidates for depth estimation (e.g., that have an estimated error (such as MAPE or other error metric) that is less than a threshold), as described herein. The subset of images may be provided to the depth estimation component 606. The depth estimation component may be another machine learning model to detect the depth of each pixel in the subset of images. Once depth estimation is performed for the subset of images, the output of the depth estimation for the subset of images may be provided to a fusion component 608. The fusion component 608 fuses the depth estimation output for the subset of images to generate a fused depth estimation output or 3D reconstruction.

In some aspects, the binary classifier may be implemented at the output of the depth estimation. For example, as shown in FIG. 6B, one or more images 601 may be provided to the depth estimation component 606, the output of which may be used to provide features (e.g., depth estimation output features) to the binary classifier 604. In some aspects, based on the images 601 and the output of the depth estimation component 606, the feature extraction component 602 may extract features (e.g., input features, such as features extracted using grayscale (and/or RGB) images and/or corner points) of the images to be provided to the binary classifier 604. Based on the output of the feature extraction component 602, the binary classifier 604 selects the subset of the images to be used for depth estimation. The binary classifier may output an indication of the selected subset of images to the fusion component 608, which may generate the fused depth estimation output (e.g., a 3D reconstruction of a scene). For example, the fusion component 608 may fuse the depth estimation outputs from the depth estimation component 606 for the subset of images that are selected by the binary classifier to generate the fused depth estimation output.

In some aspects, the depth estimation system (e.g., including the image filtering system) described herein may be implemented across separate devices. For example, an image capture device may implement part of the depth estimation system (e.g., the image filtering using sifters) while another device (e.g., a server) performs the depth estimation. In some cases, the depth network may be split between the device that captures images and a server such that part of the analysis for 3D reconstruction is performed on the image capture device and another part of the analysis for 3D reconstruction is performed on the server. In some aspects, the entirety of depth network may implemented on the server.

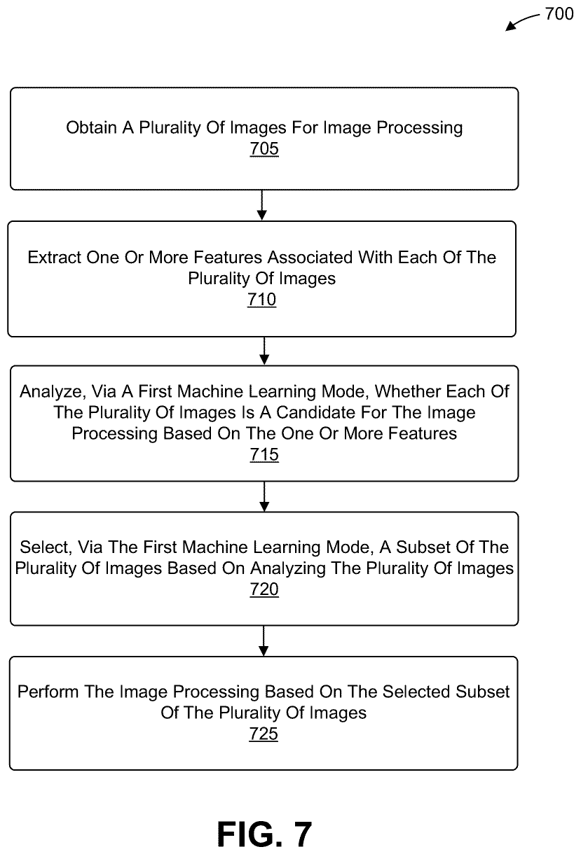

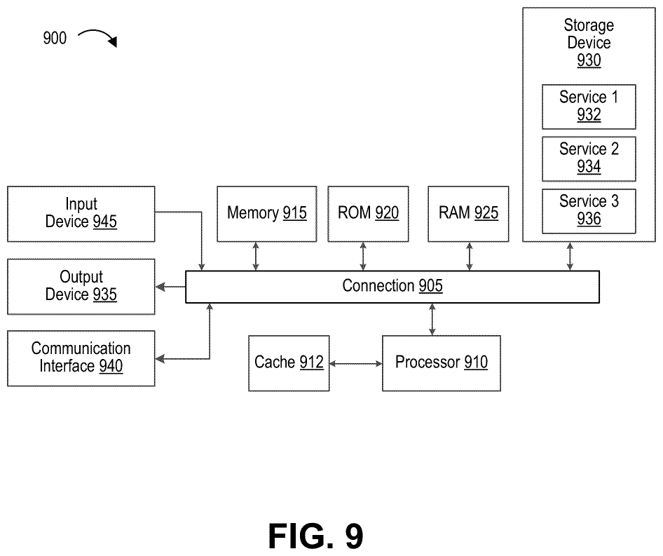

FIG. 7 is a flow diagram illustrating operations of a process 700 for processing image data. The operations of the process 700 may be performed by an image processing system (e.g., a depth estimation system), such as the processor 910, and in some aspects, storage device 930 of FIG. 9.

At block 705, the image processing system may obtain a plurality of images for image processing (e.g., depth estimation). For example, the plurality of images may be obtained from memory. At block 710, the image processing system may extract one or more features associated with each of the plurality of images. At block 715, the image processing system analyzes, via a machine learning model, whether each of the plurality of images is a candidate for the image processing based on the one or more features. The one or more features may include any combination of one or more parameters derived from each of the plurality of images, one or more parameters associated with corner points of one or more features in each of the plurality of images, and one or more parameters associated with the image processing.

At block 720, the image processing system selects, via the machine learning model, a subset of the plurality of images based on the analysis of the plurality of images. For example, the machine learning model may be trained to select the subset of the plurality of images that is estimated to have an error associated with image processing (e.g., depth estimation) that is less than a threshold.

At block 725, the image processing system performs the image processing (e.g., depth estimation) based on the selected subset of the plurality of images. In some aspects, the image processing (e.g., depth estimation) may be performed using another machine learning model. In some aspects, the image processing is performed on the plurality of images prior to (or after) the selection of the subset of plurality of images.

The systems and techniques described herein provide improved efficiencies to depth estimation techniques. Deep learning (DL) machine learning systems (e.g., DL neural networks) may be used for depth estimation in various fields including for XR, automotive applications, and mobile applications. Depth estimation may be used for 3D reconstruction, as it provides power-efficient and cost-efficient alternatives to depth sensors. However, as described herein, challenges exist due to domain gaps (e.g., differences in training and real-world use cases, camera equipment and image capture factors, etc.). Continually retraining DL machine learning systems is challenging, and it is therefore desirable to determine estimation errors for domain gaps without a need for DL retraining. In one aspect, as noted previously, a suboptimal-image filtering technique (SIFT) is used at inference time to identify and filter out images that are likely to have high errors in depth estimation, thus improving the scenes 3D reconstruction generated using a depth network. The SIFT may include a supervisory ML to train sifters for any depth estimation machine learning system (e.g., a neural network trained to perform depth estimation) using any dataset. As one example, the depth estimation systems and techniques described herein may improve depth estimation for XR applications (e.g., depth estimation for implementing augmented reality (AR), virtual reality (VR), and/or mixed reality (MR)). As another example, the depth estimation techniques described herein may be used by automotive devices (e.g., a vehicle such as an autonomous or semi-autonomous vehicle or a component or system of the vehicle) to, for example, improve object detection used to facilitate automated driving. Mobile applications may also use the depth estimation techniques provided herein. For instance, depth estimation may be used by mobile applications to implement scene segmentation, object detection (e.g., face detection), and/or other operation.

Adding more relevant features may improve the image filter system. Thus, the image

filtering system may be used with a white box approach, where feature engineering may be performed to assess the impact of other features using interpretability tools such as feature importance graphs, shapley values, and partial dependency plots to further improve the results.

TPOT may be useful to boost the recall for sifters trained. TPOT may also lead to improvements in the 3D reconstruction of these test scenes. The sifters generated using TPOT can benefit from hyper-parameter tuning. This will help reduce the size of the missing patches in 3D reconstruction, as described with respect to FIG. 3B.

In some aspects, the image processing system may be a computing device. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 700 is illustrated as a logical flow diagram, the operation of which represents a sequence of operations that can be implemented in hardware, computer instructions, or a combination thereof In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

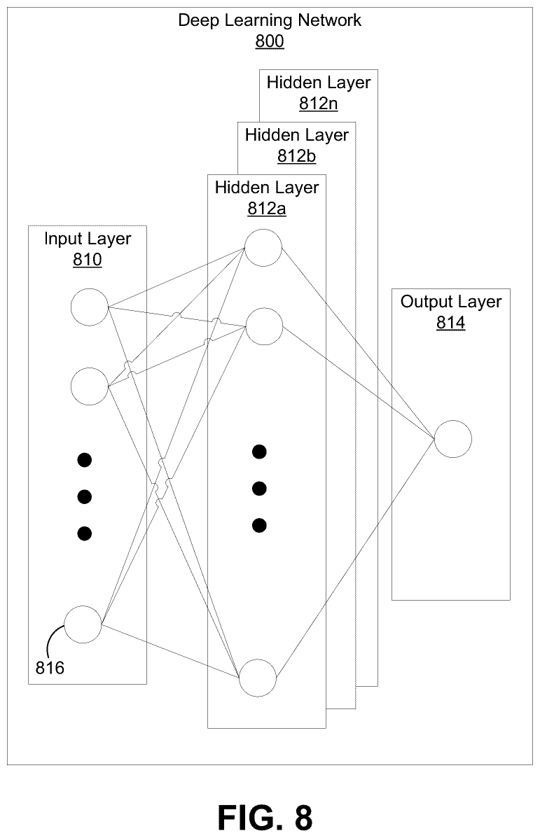

FIG. 8 is a block diagram illustrating an example of a neural network that can be used by the trained machine learning system that generates the settings used by the image signal processor (ISP), in accordance with some examples. The neural network 800 can include any type of deep network, such as a convolutional neural network (CNN), an autoencoder, a deep belief net (DBN), a Recurrent Neural Network (RNN), a Generative Adversarial Networks (GAN), and/or other type of neural network.

An input layer 810 of the neural network 800 includes input data. The input data of the input layer 810 can include data representing the pixels of an input image frame. In an illustrative example, the input data of the input layer 810 can include data representing the pixels of image data and/or metadata corresponding to the image data. The images can include image data from an image sensor including raw pixel data (including a single color per pixel based, for example, on a Bayer filter) or processed pixel values (e.g., RGB pixels of an RGB image). The neural network 800 includes multiple hidden layers 812a, 812b, through 812n. The hidden layers 812a, 812b, through 812n include “n” number of hidden layers, where “n” is an integer greater than or equal to one. The number of hidden layers can be made to include as many layers as needed for the given application. The neural network 800 further includes an output layer 814 that provides an output resulting from the processing performed by the hidden layers 812a, 812b, through 812n. In some examples, the output layer 814 can provide one or more settings.

The neural network 800 is a multi-layer neural network of interconnected filters. Each filter can be trained to learn a feature representative of the input data. In some cases, the neural network 800 can include a feed-forward network, in which case there are no feedback connections where outputs of the network are fed back into itself. In some cases, the network 800 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 810 can activate a set of nodes in the first hidden layer 812a. For example, as shown, each of the input nodes of the input layer 810 can be connected to each of the nodes of the first hidden layer 812a. The nodes of a hidden layer can transform the information of each input node by applying activation functions (e.g., filters) to this information. The information derived from the transformation can then be passed to and can activate the nodes of the next hidden layer 812b, which can perform their own designated functions. Example functions include convolutional functions, downscaling, upscaling, data transformation, and/or any other suitable functions. The output of the hidden layer 812b can then activate nodes of the next hidden layer, and so on. The output of the last hidden layer 812n can activate one or more nodes of the output layer 814, which provides a processed output image. In some cases, while nodes (e.g., node 816) in the neural network 800 are shown as having multiple output lines, a node has a single output and all lines shown as being output from a node represent the same output value.

In some cases, each node or interconnection between nodes can have a weight that is a set of parameters derived from the training of the neural network 800. For example, an interconnection between nodes can represent a piece of information learned about the interconnected nodes. The interconnection can have a tunable numeric weight that can be set (e.g., based on a training dataset), allowing the neural network 800 to be adaptive to inputs and able to learn as more and more data is processed.

The neural network 800 is pre-trained to process the features from the data in the input layer 810 using the different hidden layers 812a, 812b, through 812n in order to provide the output through the output layer 814.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof

The storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or

A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. An apparatus for processing frame data, the apparatus comprising: at least one memory; and at least one processor coupled to the at least one memory, the at least one processor configured to: obtain a plurality of images for image processing; extract one or more features associated with each of the plurality of images; analyze, via a first machine learning model, whether each of the plurality of images is a candidate for the image processing based on the one or more features; select, via the first machine learning model, a subset of the plurality of images based on analyzing the plurality of images; and perform the image processing based on the selected subset of the plurality of images.
Aspect 2. The apparatus of aspect 1, wherein the image processing comprises depth estimation.
Aspect 3. The apparatus of any one of aspects 1-2, wherein the image processing is performed using a second machine learning model.
Aspect 4. The apparatus of any one of aspects 1-3, wherein the one or more features comprise at least one of: one or more parameters derived from each of the plurality of images; one or more parameters associated with corner points of one or more features in each of the plurality of images; and one or more parameters associated with depth estimation.
Aspect 5. The apparatus of any one of aspects 1-4, wherein the at least one processor is configured to perform the image processing on the plurality of images prior to selecting the subset of the plurality of images.
Aspect 6. The apparatus of any one of aspects 1-5, wherein the first machine learning model is trained to select the subset of the plurality of images based on the subset of the plurality of images being estimated to have an error associated with the image processing that is less than a threshold.
Aspect 7. The apparatus of any one of aspects 1-6, wherein the first machine learning model is trained using labeled images generated by comparing a depth estimation output of training images to an actual depth information of the training images.
Aspect 8. A method for processing frame data, the method comprising: obtaining a plurality of images for image processing; extracting one or more features associated with each of the plurality of images; analyzing, via a first machine learning model, whether each of the plurality of images is a candidate for the image processing based on the one or more features; selecting, via the first machine learning model, a subset of the plurality of images based on analyzing the plurality of images; and performing the image processing based on the selected subset of the plurality of images.
Aspect 9. The method of aspect 8, wherein the image processing comprises depth estimation.
Aspect 10. The method of any one of aspects 8-9, wherein the image processing is performed using a second machine learning model.
Aspect 11. The method of any one of aspects 8-10, wherein the one or more features comprise at least one of: one or more parameters derived from each of the plurality of images; one or more parameters associated with corner points of each of the plurality of images; and one or more parameters associated with depth estimation.
Aspect 12. The method of any one of aspects 8-11, wherein the image processing on the plurality of images is performed prior to selecting the subset of the plurality of images.
Aspect 13. The method of any one of aspects 8-12, wherein the first machine learning model is trained to select the subset of the plurality of images based on the subset of the plurality of images being estimated to have an error associated with the image processing that is less than a threshold.
Aspect 14. The method of any one of aspects 8-13, wherein the first machine learning model is trained using labeled images generated by comparing a depth estimation output of training images to an actual depth information of the training images.
Aspect 15. A non-transitory computer-readable medium having stored thereon instructions that, when executed by one or more processors, cause the one or more processors to perform operations according to any of aspects 1 to 14.
Aspect 16. An apparatus for processing frame data, the apparatus including one or more means for performing operations according to any of aspects 1 to 14.

What is claimed is:

1. An apparatus for processing frame data, the apparatus comprising:
at least one memory; and
at least one processor coupled to the at least one memory, the at least one processor configured to:
obtain a plurality of images for image processing;
extract one or more features associated with each of the plurality of images;
analyze, via a first machine learning model, whether each of the plurality of images is a candidate for the image processing based on the one or more features;
select, via the first machine learning model, a subset of the plurality of images based on analyzing the plurality of images; and
perform the image processing based on the selected subset of the plurality of images.

2. The apparatus of claim 1, wherein the image processing comprises depth estimation.

3. The apparatus of claim 1, wherein the at least one processor is configured to perform the image processing using a second machine learning model.

4. The apparatus of claim 1, wherein the one or more features comprise at least one of:
one or more parameters derived from each of the plurality of images;
one or more parameters associated with corner points of one or more features in each of the plurality of images; and
one or more parameters associated with depth estimation.

5. The apparatus of claim 1, wherein the at least one processor is configured to perform the image processing on the plurality of images prior to selecting the subset of the plurality of images.

6. The apparatus of claim 1, wherein the first machine learning model is trained to select the subset of the plurality of images based on the subset of the plurality of images being estimated to have an error associated with the image processing that is less than a threshold.

7. The apparatus of claim 1, wherein the first machine learning model is trained using labeled images generated by comparing a depth estimation output of training images to an actual depth information of the training images.

8. A method for processing frame data, the method comprising:
obtaining a plurality of images for image processing;
extracting one or more features associated with each of the plurality of images;
analyzing, via a first machine learning model, whether each of the plurality of images is a candidate for the image processing based on the one or more features;
selecting, via the first machine learning model, a subset of the plurality of images based on analyzing the plurality of images; and
performing the image processing based on the selected subset of the plurality of images.

9. The method of claim 8, wherein the image processing comprises depth estimation.

10. The method of claim 8, wherein the image processing is performed using a second machine learning model.

11. The method of claim 8, wherein the one or more features comprise at least one of:
one or more parameters derived from each of the plurality of images;
one or more parameters associated with corner points of each of the plurality of images; and
one or more parameters associated with depth estimation.

12. The method of claim 8, wherein the image processing on the plurality of images is performed prior to selecting the subset of the plurality of images.

13. The method of claim 8, wherein the first machine learning model is trained to select the subset of the plurality of images based on the subset of the plurality of images being estimated to have an error associated with the image processing that is less than a threshold.

14. The method of claim 8, wherein the first machine learning model is trained using labeled images generated by comparing a depth estimation output of training images to an actual depth information of the training images.

15. A non-transitory computer-readable medium having instructions stored thereon, that when executed by at least one processor, causes the at least one processor to:
obtain a plurality of images for image processing;
extract one or more features associated with each of the plurality of images;
analyze, via a first machine learning model, whether each of the plurality of images is a candidate for the image processing based on the one or more features;
select, via the first machine learning model, a subset of the plurality of images based on analyzing the plurality of images; and
perform the image processing based on the selected subset of the plurality of images.

16. The non-transitory computer-readable medium of claim 15, wherein the image processing comprises depth estimation.

17. The non-transitory computer-readable medium of claim 15, wherein the image processing is performed using a second machine learning model.

18. The non-transitory computer-readable medium of claim 15, wherein the one or more features comprise at least one of:
one or more parameters derived from each of the plurality of images;
one or more parameters associated with corner points of each of the plurality of images; and
one or more parameters associated with depth estimation.

19. The non-transitory computer-readable medium of claim 15, wherein the image processing on the plurality of images is performed prior to selecting the subset of the plurality of images.

20. The non-transitory computer-readable medium of claim 15, wherein the first machine learning model is trained to select the subset of the plurality of images based on the subset of the plurality of images being estimated to have an error associated with the image processing that is less than a threshold.

21. The non-transitory computer-readable medium of claim 15, wherein the first machine learning model is trained using labeled images generated by comparing a depth estimation output of training images to an actual depth information of the training images.

22. An apparatus for processing frame data, the apparatus comprising:
means for obtaining a plurality of images for image processing;
means for extracting one or more features associated with each of the plurality of images;
means for analyzing, via a first machine learning model, whether each of the plurality of images is a candidate for the image processing based on the one or more features;
means for selecting, via the first machine learning model, a subset of the plurality of images based on analyzing the plurality of images; and
means for performing the image processing based on the selected subset of the plurality of images.

23. The apparatus of claim 22, wherein the image processing comprises depth estimation.

24. The apparatus of claim 22, wherein the image processing is performed using a second machine learning model.

25. The apparatus of claim 22, wherein the one or more features comprise at least one of:
one or more parameters derived from each of the plurality of images;
one or more parameters associated with corner points of each of the plurality of images; and
one or more parameters associated with depth estimation.

26. The apparatus of claim 22, wherein the image processing on the plurality of images is performed prior to selecting the subset of the plurality of images.

27. The apparatus of claim 22, wherein the first machine learning model is trained to select the subset of the plurality of images based on the subset of the plurality of images being estimated to have an error associated with the image processing that is less than a threshold.

28. The apparatus of claim 22, wherein the first machine learning model is trained using labeled images generated by comparing a depth estimation output of training images to an actual depth information of the training images.
